(19) United States
(12) Patent Application Publication
(10) Pub. No.: US 2010/0024293 A1
(43) Pub. Date: Feb. 4, 2010

(54) GRASS PROTECTION MAT

(76) Inventor: Chang-sub Son, Seongnam-si (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/506,820

(22) Filed: Jul. 21, 2009

(30) Foreign Application Priority Data
Jul. 29, 2008 (KR) 10-2008-0074009

(51) Int. Cl. A01G 13/02

(52) U.S. Cl. 47/20.1; 52/155

(57) ABSTRACT

A grass protection mat, used for protecting grass on golf courses, grass playing fields, park lawns, etc., or for promoting growth of grass, is provided. The grass protection mat is fixed to a ground surface through a mat anchoring member, and includes a body provided with a grass passage, a projecting column provided at a top of the body, a lug provided at a bottom of the body, and a mat ground anchoring means connected to the body, and configured with a portion to which the mat anchoring member is fixed upon mat installation and disposed at least below the body. The grass protection mat, due to its ground anchoring portions being disposed in closest possible proximity to the ground surface to improve anchoring to the ground when the ground anchoring portions are pressed during on-site installation, can offer superior results including effective prevention of being lifted, deformed, and disconnected.

### BACKGROUND OF THE INVENTION

1. Field of the Invention

The present invention relates to a grass protection mat used for protecting grass on golf courses, grass playing fields, park lawns, etc., or for promoting growth of grass, and more particularly, to a grass protection mat that, due to its ground anchoring portions being disposed in closest possible proximity to the ground surface, is capable of effectively preventing being lifted, deformed, and disconnected when the ground anchoring portions are pressed during on-site installation.

2. Description of the Related Art

On grounds such as golf courses, grass playing fields, and park lawns that grow and maintain grass, areas such as trails subject to heavy foot traffic or paths frequently traversed by vehicles (such as golf carts, in the case of golf courses) have grass that is continually pressed and damaged, thus requiring renovation and maintenance that incur hefty fees.

In order to therefore prevent damage to grass in areas with heavy foot or vehicle traffic within such facilities that maintain grass, grass protection mats are installed to alleviate loads and prevent damage to grass traversed by people or vehicles.

Referring to FIGS. 6A, 6B, 6C, and 6D, a typical grass protection mat 2 is constituted by a body 10 that forms the framework of the mat, lugs 30 that are supported on a ground surface, projecting columns 20 that support loads, cushioning arms 22 that distribute and cushion loads, and a peripheral frame 50 that maintains peripheral integrity of the mat.

A hook 60 that enables mats to be installed in connection, and an opening 70 to which the hook 60 of an adjacent mat is fastened are provided on the peripheral frame 50.

Mats are installed in connection by assembly through inserting the bent hooks 60 in the openings 70 of adjacent mats.

When installing the typical grass protection mats 2 on a ground surface, mat anchoring members 100a are inserted into the ground through holes defined at the edges of the peripheral frames of the mats to anchor the mats to the ground.

In the typical grass protection mat 2 illustrated in FIG. 6A, the mat is fixed to the ground by inserting the mat anchoring members 100a through the holes of the mat and into the ground, on account of the height imposed by the lugs 30.

With the typical grass protection mat 2 as illustrated in FIGS. 6B and 6C, however, when a visitor's foot 3 catches on the edge of a mat, rolling it upward (and lifting the mat), the mat may become deformed or break away (disengage).

Also, with the typical grass protection mat 2, mats that are not secured can not only lead to frequent accidents in which visitors trip when their feet 3 get caught on the mats, but can also cause the mat anchoring members 100a to disengage or break.

Moreover, the typical grass protection mat 2 has weak connectivity, so that mat anchoring members must be used at connecting portions when connecting 4 mats, thereby requiring a large number of mat anchoring members and increasing cost.

### SUMMARY OF THE INVENTION

Accordingly, the present invention is directed to a grass protection mat that substantially obviates one or more problems due to limitations and disadvantages of the related art.

An object of the present invention is to provide a grass protection mat capable of effectively preventing it from being lifted, deformed, and disconnected when its ground anchoring portions are pressed, due to the ground anchoring portions being disposed in closest possible proximity to the ground surface during onsite installation of the grass protection mat to thereby increase its connectivity, and also capable of preventing the occurrence of accidents caused by people tripping on typical mats that have been lifted, and especially capable of providing extended service life.

According to an embodiment of the present invention, a grass protection mat that is anchored to a ground surface by a mat anchoring member includes: a body provided with a grass passage; a projecting column provided at a top of the body; a lug provided at a bottom of the body; and a mat ground anchoring means connected to the body, and configured with a portion to which the mat anchoring member is fixed upon mat installation and disposed at least below the body.

The grass protection mat may further include a peripheral frame connected to a periphery of the body to maintain a mat shape, wherein the mat ground anchoring means is disposed at the peripheral frame.

The grass protection mat may further include: a cushioning arm provided between the projecting columns at the top of the body; a hooking means provided at the peripheral frame connected to the periphery of the body; and a fastening opening to which the hooking means of an adjacent mat is fastened

The mat ground anchoring means may include: a connecting portion extending from the peripheral frame connected to the body toward a ground; and a ground fixing portion provided at a bottom of the connecting portion to be lower than the body and proximate to the ground, and to which the mat anchoring member planted in the ground is fixed.

The connecting portion of the mat ground anchoring means may be constituted with one of a connecting column or a connecting plate integrally extending downward from the peripheral frame provided with the lug at the bottom thereof, and is integrally provided with the ground fixing portion that is horizontal at the bottom thereof, and an anchoring member hole may be defined in the ground fixing portion.

The ground fixing portion provided on the mat ground anchoring means may be formed to correspond in size to the mat anchoring member fixed thereto.

The connecting portion of the mat ground anchoring means may be integrally formed extending downward from a peripheral frame corner curved or bent inward toward the peripheral frame, or from a supporting plate connected between a corner of the peripheral frame and the body.

The connecting portion of the mat ground anchoring means may be formed to have resilience, or may further include a ridged portion, to enable skewing corresponding to an inclined ground surface.

Thus, with a grass protection mat according to the present invention, by disposing its ground anchoring portions in closest possible proximity to the ground surface, the mat is effectively prevented from being lifted, deformed, and disconnected when the ground anchoring portions are pressed during on-site installation.

Therefore, after the mat according to the present invention is installed, anchoring of the mat is improved and the mat does not lift, thereby maintaining the exterior of installed mats, preventing the possibility of accidents occurring such as people tripping on lifted portions of mats while traversing them, and most importantly, extending the service life of the mat following its installation, to yield many benefits.

Also, the edges of the mat according to the present invention are made not to roll up, in order to preserve the appearance of the mat.

Further, the present invention effectively prevents lifting of mats even without the use of packs and pins at portions connecting four mats, can drastically shorten assembly time due to good anchoring of the mat through its ground fixing portion maintaining it pressed against the ground, and also enables connections without the use of mat anchoring members at the connecting portions of 4 mats due to its good anchoring, so that many mat anchoring members are not required, thus reducing costs.

In addition, because the mat according to the present invention is disposed close to the ground, it has the function of preventing indenting of the ground surface.

### BRIEF DESCRIPTION OF THE DRAWINGS

FIG. 1 is a plan view of a grass protection mat according to an embodiment of the present invention;

FIGS. 2A and 2B are a plan view and a component view of a grass protection mat according to another embodiment of the present invention;

FIG. 3 is a sectional view illustrating the fastening structure of a grass protection mat according to the present invention;

FIGS. 4A and 4B are enlarged perspective views of region ‘A’ in FIGS. 1 and 2A, illustrating an embodiment and a modified embodiment of a mat ground anchoring means of a grass protection mat according to the present invention;

FIG. 5 is a plan view illustrating installation of a grass protection mat using a mat anchoring member according to the present invention;

FIGS. 6A to 6C are diagrams of a typical grass protection mat in lifted and deformed states;

FIGS. 6D and 6E are structural views illustrating installation of grass protection mats according to the related art and the present invention;

FIG. 7 is a structural view of another embodiment of a mat ground anchoring means for a grass protection mat according to the present invention;

FIGS. 8 and 9 are a bottom perspective view and a sectional view of a grass protection mat according to another embodiment of the present invention;

FIG. 10 is a side view of a grass protection mat according to another embodiment of the present invention; and

FIG. 11 is a side view of a grass protection mat according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

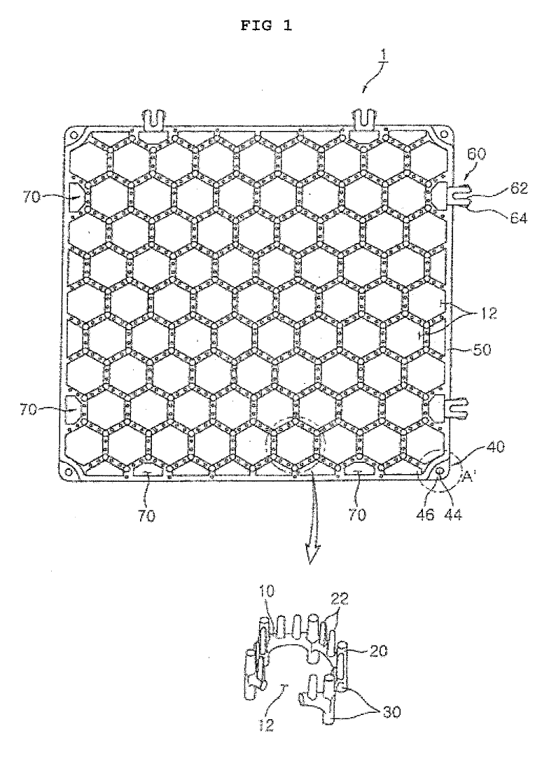

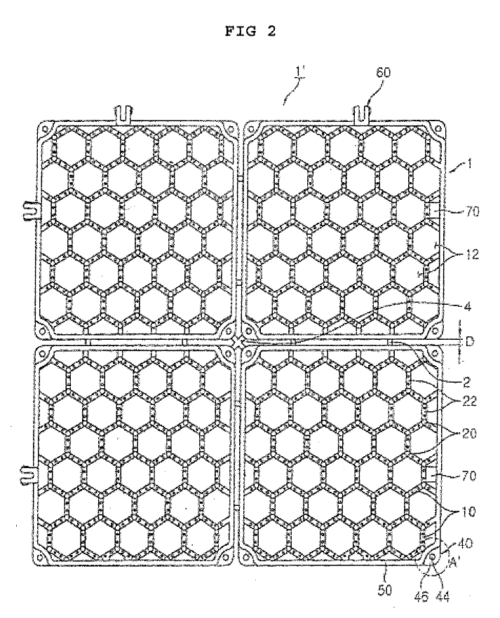

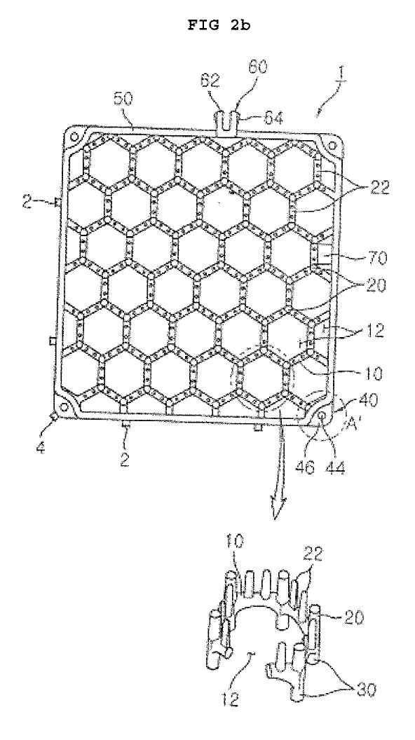

FIGS. 1 and 2 illustrate grass protection mats 1 and 1′ according to an embodiment of the present invention, where FIG. 1 illustrates a single mat, and FIGS. 2A and 2B illustrate the single mat 1 combined to configure a mat assembly 1′.

However, when the grass protection mat in FIG. 1 or a plurality of the grass protection mats 1 are connected with connectors 2 and 4 to form the mat assembly 1′ illustrated in FIG. 2, the basic configuration is substantially the same.

The only difference lies in the positions of the hook 60 and opening 70.

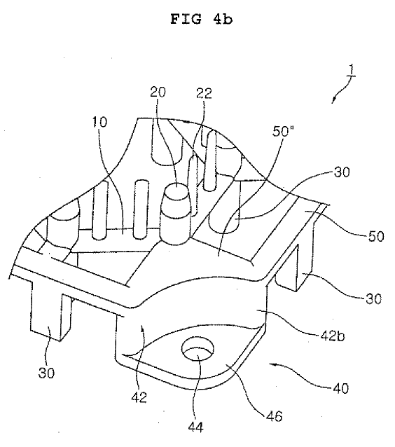

For example, based on FIGS. 1 and 2B (illustrating a single mat of the mat assembly in FIG. 2A), a grass protection mat 1 according to the present invention is basically constituted with a body 10 defining a grass passage 12, projecting columns 20 provided at the top of the body 10, lugs 30 provided at the bottom of the body 10, and a mat ground anchoring means 40 integrally configured with the body 10, where portions, to which mat anchoring members (100a, 100b, and 110′ in FIG. 4A) are fastened, are disposed at least below the body 10 when the mat is installed.

The body 10 in the grass protection mat 1 defines a grass passage 12 for promoting grass growth and rooting that is polygonal (preferably hexagonal) or round in shape, and a plurality of bodies 10 are interconnected to constitute an overall mat.

For example, with a grass protection mat 1 according to the present invention, bodies 10 that define hexagonal grass passages are connected to one another. Because employing the hexagonal shape provides larger grass passages than the typical rectangular shape, it allows for better photosynthesis of grass, so that grass is better able to take root and grow after the mat is installed.

Also, the hexagonally configured body 10 does not form empty spaces, allowing the mat to optimally retain its strength.

However, the body described as a hexagon in this embodiment is but one example, and is not necessarily limited thereto, and may of course be alternatively embodied in rectangular, octagonal, circular and other shapes according to requirements.

The projecting column 20 provided on the grass protection mat 1 illustrated in FIGS. 1 and 2A and 2B according to the present invention is formed extending vertically upward from corners of the hexagonal body. The projecting column 20 supports the weight of moving bodies (such as people and carts) traversing the mat.

The lug 30 provided on the bottom of the body 10 is vertically and integrally formed at the bottom of the body 10 (at the corners of a hexagonal body) to allow the ground to support the mat and maintain a gap between the ground surface and the mat, providing room for grass to grow.

The lug 30 may be formed along the bottom of the peripheral frame 50.

As illustrated in FIGS. 1 and 2B, the grass protection mat 1 according to the present invention may further include cushioning arms 22 formed integrally with and projecting vertically from the top of the body 10 between the projecting columns 20.

The cushioning arms 22 project further than the projecting columns 20, and a larger number are installed than the projecting columns 20, in order to distribute load, while being similar in form to the grass that the mat is protecting, thereby improving the appearance of the mat and making it appropriate for grass growing areas.

As illustrated in FIGS. 1 and 2A and 2B, the grass protection mat 1 according to the present invention is provided with a peripheral frame 50 integrally connected at the periphery of the bodies 10 to extend in an overall rectangular shape, retaining the peripheral integrity of the mat.

Accordingly, the mat ground anchoring means 40 (to be described in detail with reference to FIG. 4) is disposed at the peripheral frame (specifically, its corners) in FIGS. 1 and 2A and 2B.

As illustrated in FIGS. 1 and 2A and 2B, the grass protection mat 1 according to the present invention may include hooking means 60 and fastening holes 70 that are disposed at the peripheral frame in arrangement about its diagonal centerlines, enabling interconnected installation of multiple mats through the hooking means 60 of one mat being coupled and fixed to the fixing holes 70 of an adjacent mat.

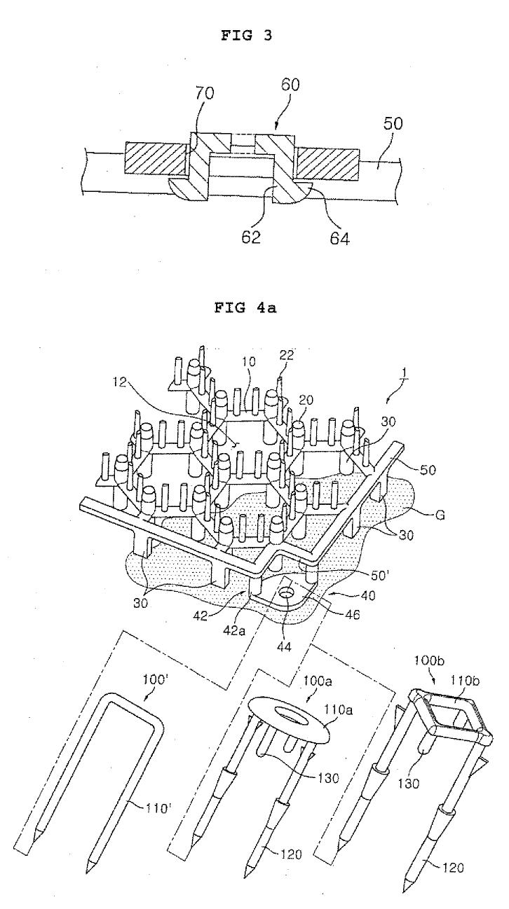

Specifically, as illustrated in FIGS. 1, 2B, and 3, the hooking means 60 according to the present invention may be integrally formed with the peripheral frame 50, the center of the hook body 62 may have a contractible cutaway, and hooks 64 may be formed at lower portions on either outer side of the hook body 62, so that when mats are connected, the hooking means 60 of one mat may be inserted in and fastened to a corresponding fastening hole 70 of an adjacent mat, as illustrated in FIG. 3, thus connecting the mats.

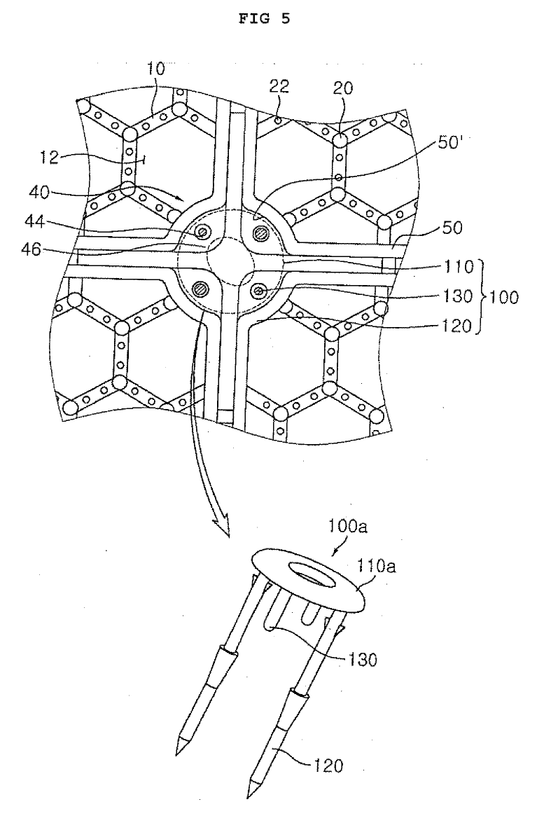

FIGS. 4A, 4B, and 5 illustrate mat ground anchoring means 40 of a grass protection mat 1 according to the present invention.

As illustrated in FIGS. 4A, 4B, and 5, a mat ground anchoring means 40 according to the present invention is specifically constituted of a connecting portion 42 linked to the body 10 and extending toward the green G from the peripheral frame 50 configuring the outer perimeter of the mat (or more specifically, from the corners of the peripheral frame 50), and a fixing port-ion 46 provided at the lower end of the connecting portion 42 extending downward at least lower than the body to contact the ground, and to which a mat anchoring member 100a, 100b, or 100′ (that is planted in the ground) is fixed.

The ground fixing portion 46 of the mat ground anchoring means 40 defines an anchoring member hole 44 in which a mat anchoring member 100a, 100b, or 100′ (that is fastened to ground fixing portion 46 of an adjacent mat and planted in the green G) is inserted and fixed.

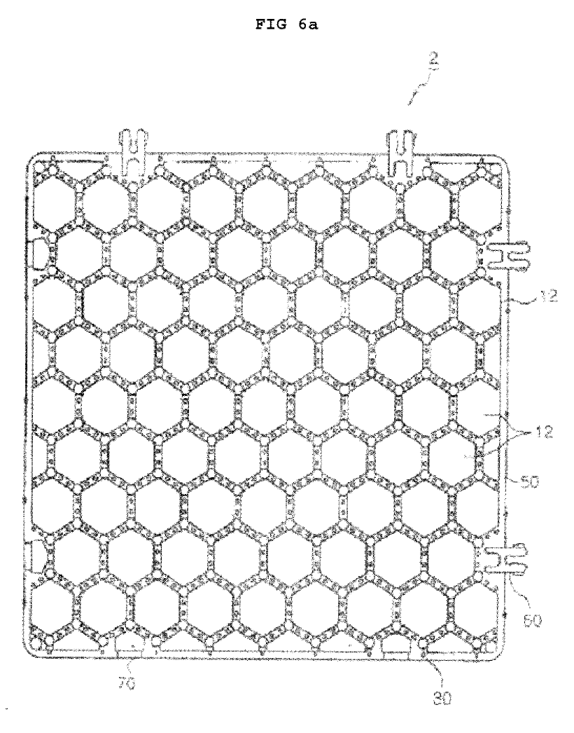

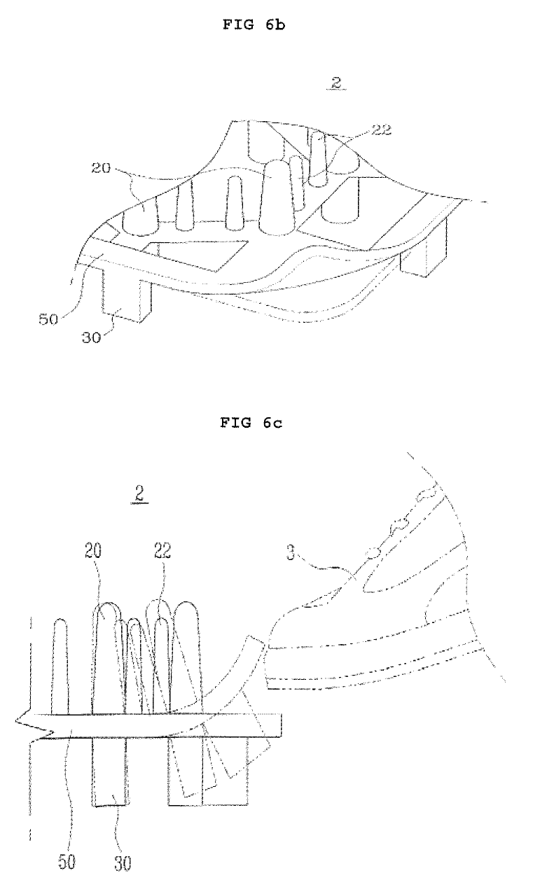

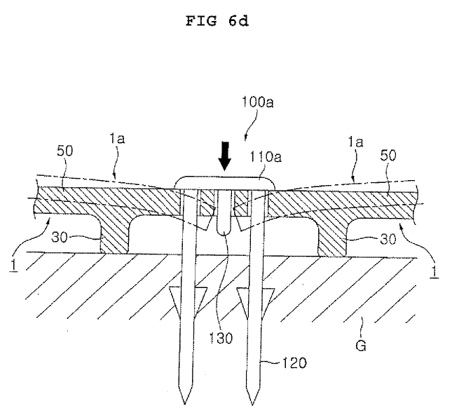

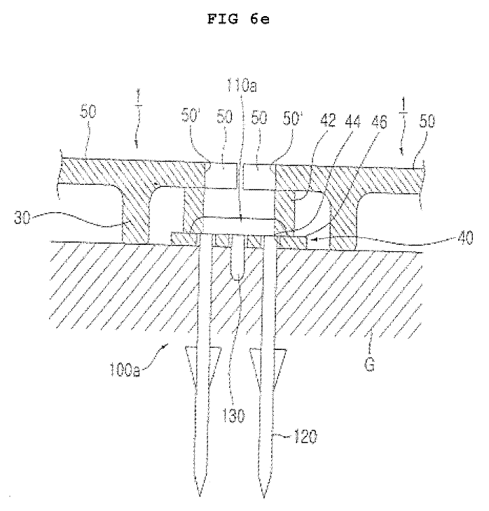

In the related art, as illustrated in FIGS. 6A through 6D, because lugs 30 are formed at the bottoms of the body 10 and the mat peripheral frame 50, and the corners of the peripheral frame 50 in which the mat anchoring member 100a (or 100b or 100′ in FIG. 4A) are fixed are separated from the ground by the lugs when the anchoring plates 100a (or 110b or 110b in FIG. 4A) of the mat anchoring member are pressed during planting of the anchoring columns 120 or 110′ of the mat anchoring member in the ground, the mat 1a may be lifted or may even disengage in severe cases. (The related art in FIGS. 6A through 6D has been described with the reference numerals of the present embodiment.)

However, as illustrated in FIG. 6E, with a grass protection mat according to the present invention, because holes 44 are defined in which columns 120 or 110′ of the mat anchoring member 100a (or 100b or 100′ in FIG. 4A) planted in the ground are fastened, and because the ground fixing portion 46 (against which the tops of round anchoring plates 110a, rectangular anchoring frames 110b and wire anchoring members 110′ for the mats are pressed against) is integrally formed at the bottom of the connecting portion 42 that extends downward from the peripheral frame 50, even when the ground anchoring columns 120 and 110′ of the anchoring members 100a, 100b, or 100′ are planted in the green G, the mat will not lift or deform as in the related art of FIGS. 6A through 6D.

The downwardly extending length of the connecting portion 42 may be made substantially equal to the length of the lug 30 provided at the bottom of the peripheral frame or the body, taking into account the ground fixing portion 46 pressed against the ground. That is, the downwardly extending length of the connecting portion 42 should be made corresponding to the length of the lug.

The mat anchoring member described above (that is fixed to the anchoring means 40 according to the present invention and allows installation of the mat on the ground) may employ the anchoring member 100′ of wire that is bent and provided with the column 110′ that is planted in the ground (as illustrated in FIG. 4A), or anchoring members 100a and 100b made of a separately formed material.

Here, the anchoring members 100a and 100b formed, as illustrated in FIG. 4A, include a circular anchoring plate 110a or a rectangular anchoring frame 110b that is provided at either side thereof with ground anchoring columns 120 that are simultaneously passed through holes 44 in ground fixing portions 46 of mat ground anchoring means 40 of one mat and an adjacent mat, and planted in the ground.

According to the present invention, because the ground fixing portion of the mat is maintained securely against the ground, the mat is strongly secured, and mat anchoring members need not be used at all connecting portions that connect 4 mats, so that costs can be considerably reduced from not requiring a large number of mat anchoring members.

As a hole or opening is defined in the central portions of the circular anchoring plate and the rectangular anchoring frame, growing grass is able to pass therethrough.

Also, two anchoring projections 130 may be provided diagonally opposed at sides of the ground anchoring columns provided at the bottom of the circular anchoring plate 110a and rectangular anchoring frame 110b of the anchoring members 100a and 100b.

Therefore, as illustrated in FIG. 5, when mats are installed on the ground, of the four holes 44 of the ground fixing portions of the mat ground anchoring means 40 disposed at the corners of a total of 4 mats, the ground anchoring columns 120 of an anchoring member are passed through two of the holes 44 that are diagonal and planted in the ground.

Here, the circular anchoring plate 110a (or rectangular anchoring frame 110b in FIG. 4A) may press 4 ground fixing portions 46 (that is, the horizontal ground fixing portions pressed against the ground), and two different anchoring projections 130 on the bottom of the anchoring plate (or rectangular anchoring frame) may be inserted through 2 holes 44 to allow installation of ground fixing portions 46 of mat ground anchoring means 40 at corners of 4 mats with one anchoring member 100a or 100b.

Further, as illustrated in FIGS. 4A and 4B, the connecting portion 42 of the mat ground anchoring means 40 may preferably extend downward integrally from the peripheral frame of a mat, and the ground fixing portion at the bottom thereof may be integrally formed horizontally with one of a connecting portion 42a or connecting plate 42b.

Specifically, connecting columns 42a may be integrally formed at the corner of the peripheral frame 50 separated from one another, and the horizontal plate-shaped ground fixing portion 46 may be formed at the bottoms thereof, and the connecting plate 42b may be formed in a rounded shape, and the ground fixing portion may be integrally formed horizontally at the bottom thereof.

As illustrated in FIGS. 4 and 5, the ground fixing portion 46 provided at the bottom of the mat ground anchoring means 40 may be formed to correspond in size with the mat anchoring member 100a, 100b, or 100′ that is fastened in the spaces between the mats during mat installation. For example, as illustrated in FIGS. 4A and 5, when the ground anchoring columns 120 provided on the bottom of the circular anchoring plate 110a or rectangular anchoring frame 110b of the formed fixing members 100a or 100b are planted in the ground, because the ground fixing portions 46 are pressed and fixed, the ground fixing portions 46 may be formed corresponding in size to the circular anchoring plate 110a or rectangular anchoring frame 110b of the anchoring member.

That is, as illustrated in FIG. 5, because four mat fixing portions 46 of four mat corners are pressed and fixed to the ground with one anchoring member 100, 100a, or 100b, the latter may especially be formed to correspond in size to the circular anchoring plate 100a or rectangular anchoring frame 110b of the anchoring member 100a or 100b.

For example, if the sizes of the ground fixing portion and the anchoring members are not controlled, it would be difficult to uniformly maintain gaps between mats connected with hooking means. While the wire anchoring member 100′ in FIG. 4A would have a smaller anchoring member contacting area than the circular anchoring plate or rectangular anchoring frame that is formed, because a certain contacting area is formed by one horizontal ground fixing plate, the ground fixing portion 46 configures a ground fixing structure.

Additionally, the positions and diameters of the anchor holes 44 defined in the ground fixing portions 46 may be made to correspond to the positions of the ground anchoring columns of the anchoring members.

Here, as illustrated in FIGS. 4A, 4B, and 5, the connecting portions 42 of the mat ground anchoring member 40—that is, the connecting columns 42a or the connecting plates 42b—may be formed curved inward into the peripheral frame 50 or cut into the peripheral frame corner 50′, or integrally formed extending downward from the supporting plate 50″ connected from the peripheral frame corner to the body 10.

The peripheral frame corner 50′ is curved or bent in toward the mat as illustrated, and the supporting plate 50″ also has a curved corner surface, so that when the ground anchoring columns 110′ or 120 of the mat anchoring members 100a, 100b, or 100′ are passed through the holes 44 of the ground fixing portions 46 and planted in the ground, space can be secured for the circular anchoring plate 110a or rectangular anchoring frame 110b to press the ground fixing portion.

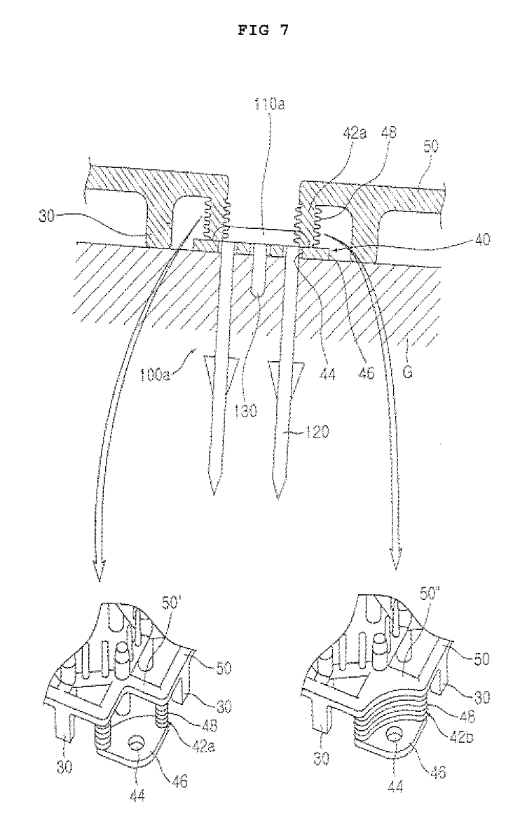

As illustrated in FIG. 7, when the connecting portion 42 (or connecting columns 42a and connecting plate 42b) of the mat ground anchoring means 40 in the mat according to the present invention are used to install mats on an inclined ground surface, they may be formed to have resilience for bending, or a separate ridged portion 48 may further be included

That is, as illustrated in FIG. 7, as opposed to the related art, with a mat ground anchoring means 40 provided for a grass protection mat 1 according to the present invention, because a ground fixing portion 46, in which a mat anchoring member 100a, 100b (in FIG. 4A), or 100′ is fastened and planted in the ground, is lower than the body at the peripheral frame 50 and actually pressed against the ground, when mats are installed on an inclined ground surface, by forming the connecting portion 42 of the mat ground anchoring means 40 with a resilient material or providing a ridged portion 48 to allow skewing, the fastened strength of the ground fixing portion 46 to the ground can be improved.

While not illustrated in the diagrams, even when installed on extremely rough terrain, entire lifting of a mat can be prevented by enabling a degree of skewing in the connecting portions.

To summarize the description thus far on installation of the grass protection mat according to the present invention, with the ground fixing portions 46 (of ground anchoring means 40 that are disposed at each corner of the peripheral frame of a single mat 1 in FIG. 1 or a group of single mats constituting a mat assembly 1′) in close proximity to the green G and the mats arranged, the mat anchoring members 100a, 100b, or 100′ are inserted simultaneously through the holes 44 of the ground fixing portions of adjacent mats and planted in the ground, thus allowing installation of the mats while preventing lifting or deformation thereof.

Here, with a plurality of mats connected with hooking means and installed, anchoring members are passed through the corners thereof and planted in the ground to complete installation.

The anchoring members 100a, 100b, and 100′ according to embodiments of the present invention as illustrated in FIG. 4A are only representative examples, and other forms of mat anchoring members may be used, such as columns that are passed through the holes 44 of the ground fixing portion 46 and planted in the ground, combined with plates of a predetermined area at the bottom of which the columns are attached.

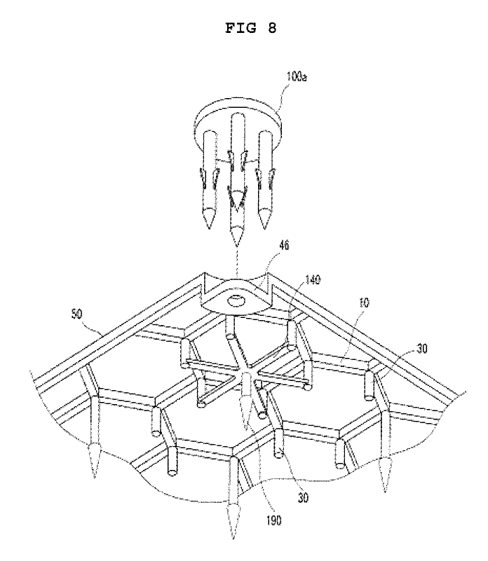

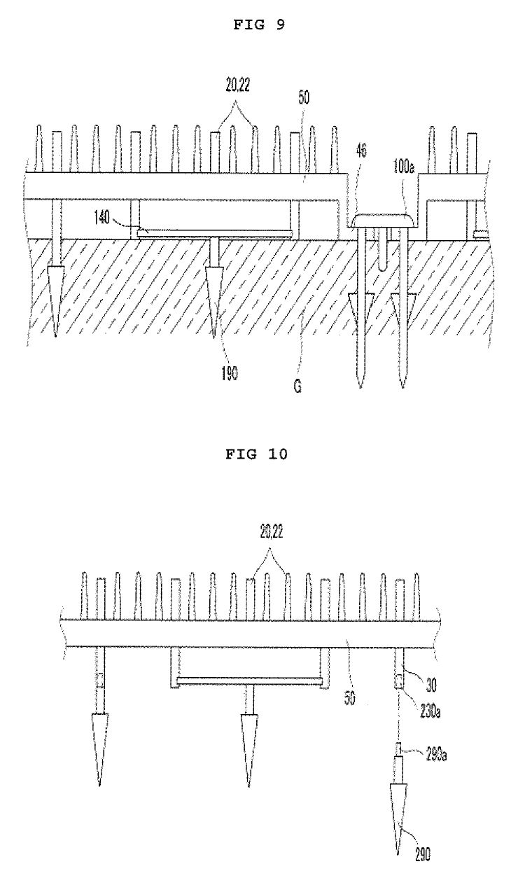

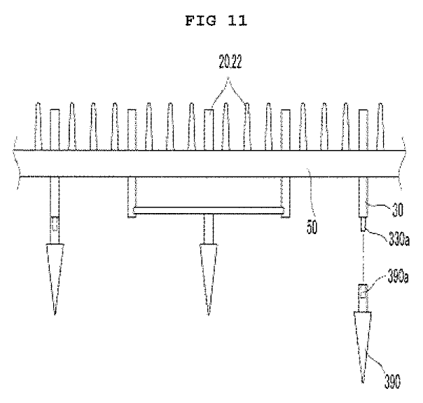

FIGS. 8 and 9 are a bottom perspective view and a sectional view of a grass protection mat according to another embodiment of the present invention, FIG. 10 is a side view of a grass protection mat according to another embodiment of the present invention, and FIG. 11 is a side view of a grass protection mat according to another embodiment of the present invention.

First, as illustrated in FIGS. S and 9, a grass protection mat according to another embodiment of the present invention is provided with a plurality of projecting columns 20 and cushioning arms 22 formed projecting from a top surface of the body 10, a plurality of lugs 30 formed at the bottom of the body 10 and supported on the green G, a plurality of anti-indentation arms 140 formed at points connecting the lugs 30 to prevent indenting of the green G, a peripheral frame 50 formed at the outer perimeter of the body 10, a ground fixing portion 46 formed at corners of the peripheral frame 50 at the same height as the lugs 30 to press against the green G when the mat is installed, and a mat anchoring member 100a inserted in the ground fixing portion 46 and anchored in the ground.

Also, a ground anchoring pin 190 is integrally formed at the end of the lug 30 to be anchored in the ground. The shape of the ground anchoring pin 190 is not limited to one particular shape, and may be any shape that can be firmly anchored in the ground.

Further, the positions at which the ground anchoring pin 190 is formed are not specifically limited and may be appropriately determined according to the conditions of the green G, by positioning more ground anchoring pins 190 in regions prone to indentation and less ground anchoring pins 190 in regions less prone to indentation.

The ground anchoring pins may not only be formed integrally, but may alternatively be detachably configured. Because a detachable configuration enables the ground anchoring pins to be suitably positioned according to the state of the green G, connectivity with the ground can be enhanced.

For example, for a modified ground anchoring pin 290 illustrated in FIG. 10, a coupling socket 230a may be defined in the end of the lug 30, and a coupling projection 290a may be formed at the end of the ground anchoring pin 290 to couple with the coupling socket 230a.

Furthermore, for another modified ground anchoring pin 390 illustrated in FIG. 11, a coupling projection 330a may be formed at the end of the lug 30, and a coupling socket 390a may be defined in the end of the ground anchoring pin 390 to couple with the coupling projection 330a.

Thus, with a grass protection mat according to the present invention, by disposing its ground anchoring portions in closest possible proximity to the ground surface, the mat is effectively prevented from being lifted, deformed, and disconnected when the ground anchoring portions are pressed during on-site installation.

Therefore, after the mat according to the present invention is installed, anchoring of the mat is improved and the mat does not lift, thereby maintaining the exterior of installed mats, preventing the possibility of accidents occurring such as people tripping on lifted portions of mats while traversing them, and most importantly, extending the service life of the mat following its installation, to yield many benefits.

Also, the edges of the mat according to the present invention are made not to roll up, in order to preserve the appearance of the mat.

Further, the present invention effectively prevents lifting of mats even without the use of packs and pins at portions connecting four mats, and can drastically shorten assembly time due to good anchoring of the mat through its ground fixing portion maintaining it pressed against the ground.

In addition, because the mat according to the present invention is disposed close to the ground, it has the function of preventing indenting of the ground surface.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A grass protection mat fixed to a ground surface through a mat anchoring member, the grass protection mat comprising:
a body (10) provided with a grass passage (12);
a projecting column (20) provided at a top of the body (10);
a lug (30) provided at a bottom of the body (10); and
a mat ground anchoring means (40) connected to the body (10), and configured with a portion to which the mat anchoring member is fixed upon mat installation and disposed at least below the body (10).

2. The grass protection mat of claim 1, further comprising a peripheral frame (50) connected to a periphery of the body (10) to maintain a mat shape, wherein the mat ground anchoring means (40) is disposed at the peripheral frame (50).

3. The grass protection mat of claim 1, further comprising:
a cushioning arm (22) provided between the projecting columns (20) at the top of the body (10);
a hooking means (60) provided at the peripheral frame (50) connected to the periphery of the body (10); and
a fastening opening (70) to which the hooking means (60) of an adjacent mat is fastened.

4. The grass protection mat of claim 1, wherein the mat ground anchoring means (40) comprises:
a connecting portion (42) extending from the peripheral frame (50) connected to the body (10) toward a ground (G); and
a ground fixing portion (46) provided at a bottom of the connecting portion (42) to be lower than the body (10) and proximate to the ground (G), and to which the mat anchoring member planted in the ground (G) is fixed.

5. The grass protection mat of claim 4, wherein the connecting portion (42) of the mat ground anchoring means (40) is constituted with one of a connecting column (42a) or a connecting plate (42b) integrally extending downward from the peripheral frame (50) provided with the lug (30) at the bottom thereof, and is integrally provided with the ground fixing portion (46) that is horizontal at the bottom thereof, and an anchoring member hole (44) is defined in the ground fixing portion (46).

6. The grass protection mat of claim 4, wherein the ground fixing portion (46) provided on the mat ground anchoring means (40) is formed to correspond in size to the mat anchoring member fixed thereto.

7. The grass protection mat of claim 4, wherein the connecting portion (42) of the mat ground anchoring means (40) is integrally formed extending downward from a peripheral frame corner (50′) curved or bent inward toward the peripheral frame (50), or from a supporting plate (50″) connected between a corner of the peripheral frame (50) and the body (10).

8. The grass protection mat of claim 4, wherein the connecting portion (42) of the mat ground anchoring means (40) is formed to have resilience, or further comprises a ridged portion (48), to enable skewing corresponding to an inclined ground surface.

9. The grass protection mat of claim 1, further comprising a ground anchoring pin (190) provided at an end of the lug (30), for anchoring in the ground.

10. The grass protection mat of claim 1, further comprising a ground anchoring pin (290) provided with a coupling projection (290a) at an end thereof, wherein the lug (30) defines a coupling socket (230a) in an end thereof with which the coupling projection (290a) couples.

11. The grass protection mat of claim 1, further comprising a ground anchoring pin (390) defining a coupling socket (390a) in an end thereof, wherein the lug (30) is provided with a coupling projection (330a) at an end thereof that couples with the coupling socket (390a).

12. The grass protection mat of claim 2, further comprising:
a cushioning arm (22) provided between the projecting columns (20) at the top of the body (10);
a hooking means (60) provided at the peripheral frame (50) connected to the periphery of the body (10); and
a fastening opening (70) to which the hooking means (60) of an adjacent mat is fastened.

13. The grass protection mat of claim 2, wherein the mat ground anchoring means (40) comprises:
a connecting portion (42) extending from the peripheral frame (50) connected to the body (10) toward a ground (G); and
a ground fixing portion (46) provided at a bottom of the connecting portion (42) to be lower than the body (10) and proximate to the ground (G), and to which the mat anchoring member planted in the ground (G) is fixed.
